(19) United States
(12) Patent Application Publication
(10) Pub. No.: US 2026/0022252 A1
(43) Pub. Date: Jan. 22, 2026

(54) ULTRAVIOLET-CURABLE COMPOSITION AND USE THEREOF

(71) Applicant: DOW TORAY CO., LTD., Shinagawa-Ku, Tokyo (JP)

(72) Inventors: Tomoka HOSOKAWA, Ichihara-Shi, Chiba (JP); Takuya OGAWA, Ichihara-shi, Chiba (JP); Yuki YOKOUCHI, Ichihara-shi, Chiba (JP)

(21) Appl. No.: 19/114,260

(22) PCT Filed: Sep. 19, 2023
(86) PCT No.: PCT/JP2023/033998

§ 371 Date: Mar. 21, 2025

(30) Foreign Application Priority Data
Sep. 22, 2022 (JP) 2022-151784

(51) Int. Cl. C09D 4/06; C09D 133/08; C09D 133/10; C09D 135/02; C09J 4/06; C09J 133/08; C09J 133/10; C09J 135/02

(52) U.S. Cl. CPC C09D 4/06; C09D 133/08; C09D 133/10; C09D 135/02; C09J 4/06; C09J 133/08; C09J 133/10; C09J 135/02

(57) ABSTRACT

Provided is a UV-curable composition containing a silicon atom, that has high adjustability of mechanical properties of a product obtained by curing, and excellent workability when applied to a base material, even as a solvent-free type. A UV-curable composition contains: when the total mass of the composition is 100 parts by mass, (A) 1 to 99 parts by mass of a compound having one or more (meth)acryloxy group in one molecule, and (B) 99 to 1 part by mass of an organopolysiloxane having two or more alkenyl groups and at least one aromatic hydrocarbon group with 6 to 20 carbon atoms in one molecule, and having no UV-curable functional group. The composition is substantially free of an organic solvent.

### TECHNICAL FIELD

The present invention relates to a UV-curable composition curable by actinic rays, such as UV rays or electron beam, particularly a UV-curable composition containing an organosilicon compound, preferably an organopolysiloxane, and more particularly to a UV-curable composition in which a cured product obtained therefrom has high viscosity adjustability and excellent coatability. The curable composition of the present invention is suitable as an insulating material for electronic and electrical devices, and particularly as a material for use as a coating agent. Furthermore, the composition has excellent coatability, excellent wettability to a base material, and viscosity adjustability, and thus is also useful as an injection molding material and an inkjet printing material.

### BACKGROUND ART

Due to high heat resistance and excellent chemical stability, silicone resins have been used as coating agents, potting agents, insulating materials, and the like for electronic and electrical devices. Silicone resins are reported to include UV-curable silicone compositions.

Touch panels are used in various display devices such as mobile devices, industrial equipment, car navigation systems, and the like. In order to improve detection sensitivity, electrical influence from light emission sites such as light-emitting diodes (LED), organic EL devices (OLED), and the like must be suppressed, and an insulating layer is usually disposed between the light-emitting part and the touchscreen.

On the other hand, thin display devices such as OLEDs and the like have a structure in which a plurality of functional thin layers are laminated. In recent years, studies have been started in order to improve the overall reliability of display devices, particularly flexible display devices, by laminating an insulating layer with high flexibility onto the touchscreen layer. Furthermore, the inkjet printing method has been adopted as a processing method for organic layers in order to improve productivity. Therefore, a material that can be processed by the inkjet printing method is required for the aforementioned insulating layer.

Japanese Unexamined Patent Application 2016-56330 discloses a UV-curable organopolysiloxane composition containing a polysiloxane having a methacryloxy functional group, a polysiloxane having two or more acryloxy functional groups in one molecule, and a polysiloxane containing alkenyl groups at both ends, and also discloses a silicone gel cured product obtained from the composition.

Furthermore, International Patent Application WO2018-3381 discloses an inkjet ink composition containing a UV-curable silicone composition containing: a polysiloxane having two (meth)acryloxy functional groups in one molecule; and an acrylate compound that does not contain a silicon atom. The composition disclosed herein does not have a sufficiently high viscosity adjustability, and it is difficult to obtain a low-viscosity composition that can be used in an inkjet method.

### RELATED ART DOCUMENTS

### Patent Documents

Patent Document 1: Japanese Unexamined Patent Application 2016-56330

Patent Document 2: WO2018-3381

### SUMMARY OF THE INVENTION

### Problem to be Solved by the Invention

As described above, several UV-curable compositions containing an organopolysiloxane having an acryloxy functional group are well known, but there is still a need for a UV-curable composition that allows for easy adjustment of the mechanical properties of a cured product and has excellent workability, particularly high viscosity adjustability, for applying to a base material. The present invention proposes a curable composition, and particularly a UV-curable composition, containing a silicon atom, the composition having high adjustability for the mechanical properties of a product obtained by curing, and excellent workability when applied to a base material, even as a solvent-free type.

### Means for Solving the Problem

The present invention was completed due to the discovery that a composition containing, when the total mass of the composition is 100 parts by mass:
(A) 1 to 99 parts by mass of a compound having one or more (meth) acryloxy group in one molecule; and
(B) 99 to 1 part by mass of an organopolysiloxane having two or more alkenyl groups and at least one aromatic hydrocarbon group with 6 to 20 carbon atoms in one molecule, and having no UV-curable functional group,
   exhibits a viscosity that allows coating even without substantially using an organic solvent, a cured product thereof has excellent mechanical properties, and the viscosity of the composition and the mechanical properties of the cured product can be easily adjusted.

The present invention relates to a UV-curable composition containing an organosilicon compound, particularly a UV-curable organopolysiloxane composition, and the present composition is cured by a UV-curable functional group forming a bond. However, the curing method is not limited to UV irradiation, and an arbitrary method in which a UV-curable functional group can cause a curing reaction can be used. For example, electron beam irradiation may be used to cure the composition of the present invention.

The UV-curable composition of the present invention is characterized by containing, when the total mass of the composition is 100 parts by mass:
(A) 1 to 99 parts by mass of a compound having one or more (meth) acryloxy group in one molecule; and
(B) 99 to 1 part by mass of an organopolysiloxane having two or more alkenyl groups and at least one aromatic hydrocarbon group with 6 to 20 carbon atoms in one molecule, and having no UV-curable functional group, wherein
   the composition is substantially free of an organic solvent.

Note that unless otherwise specified in the present specification, the viscosity of a substance is the value measured using an E-type viscometer at 25° C.

The viscosity of the entire composition, as measured at 25° C. using an E-type viscometer, is preferably 500 mPa·s or less.

The aforementioned component (B) is preferably a linear, branched, or cyclic organopolysiloxane expressed by the average compositional formula:

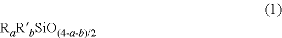

(where R represents an alkenyl group;
R′ represents a group selected from monovalent hydrocarbon groups excluding alkenyl groups as well as hydroxyl groups, and alkoxy groups; and
a and b are numbers satisfying the following conditions: 1≤a+b≤3 and 0.05≤a/(a+b)<1.0, there are at least two Rs in a molecule, and at least one of the R's is an aromatic hydrocarbon group with 6 to 20 carbon atoms).

The organopolysiloxane of component (B) is preferably one type or more of an organopolysiloxane having at least two alkenyl groups and one or more aromatic hydrocarbon group with 6 to 20 carbon atoms, the organopolysiloxane being selected from the group consisting of:
organopolysiloxanes expressed by the following formula (2):

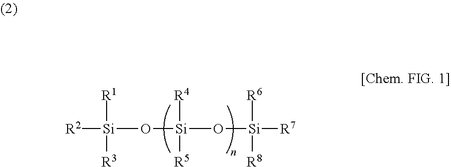

(where of all of R¹ to R⁸ groups, at least two alkenyl groups are present in a molecule; at least one aromatic hydrocarbon group with 6 to 20 carbon atoms is present in a molecule; the remaining R¹ to R⁸ each independently represent an unsubstituted or fluorine-substituted monovalent hydrocarbon group, a hydroxyl group, or an alkoxy group; and n is a numerical value of 0 or more and 1,000 or less);
branched organopolysiloxanes expressed by average unit formula (3):

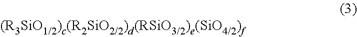

(where R each independently represents a group selected from alkenyl groups, unsubstituted or fluorine-substituted monovalent hydrocarbon groups, hydroxyl groups, and alkoxy groups, and of all Rs, at least two are alkenyl groups and at least one is an aromatic hydrocarbon group with 6 to 20 carbon atoms, (e+f) is a positive number, c is 0 or a positive number, and d is a number in the range of 0 to 100);
cyclic organopolysiloxanes expressed by the following formula (4):

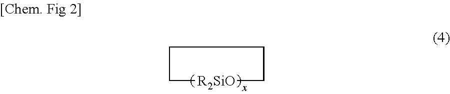

(where R each independently represents a group selected from alkenyl groups and unsubstituted or fluorine-substituted monovalent hydrocarbon groups, x is an integer from 3 to 10, and at least two alkenyl groups and at least one aromatic hydrocarbon group with 6 to 20 carbon atoms are present in a molecule); and
mixtures of these organopolysiloxanes.

The aforementioned component (B) preferably includes the linear organopolysiloxane expressed by the aforementioned formula (2), having two alkenyl groups and at least one aromatic hydrocarbon group with 6 to 20 carbon atoms in one molecule.

The aforementioned component (A) may be a compound having one (meth)acryloxy group or a mixture of a compound having one (meth)acryloxy group and a compound having two or more (meth)acryloxy groups.

The aforementioned compound having one (meth)acryloxy group in component (A) is preferably the following (A1) or (A2).
(A1) One type or more of a compound having one (meth) acryloxy group and having no silicon atom
(A2) A mixture of (A1) and one type or more of a compound having one (meth) acryloxy group and having a silicon atom

The aforementioned component (A) preferably includes a compound having at least one type of acryloxy group.

The aforementioned amount of aromatic hydrocarbon groups with 6 to 20 carbon atoms of component (B) is preferably 10 mol % or more with respect to all substitution groups on silicon atoms.

The viscosity of the entire composition, as measured at 25° C. using an E-type viscometer, is preferably in the range of 5 to 60 mPa·s.

The present invention further provides an insulating coating agent or insulating adhesive containing the aforementioned UV-curable composition. The UV-curable composition of the present invention is useful as an insulating coating agent or insulating adhesive.

The present invention further provides a cured product of the aforementioned UV-curable composition. Furthermore, the present invention also provides a method of using the cured product as an insulating coating layer or insulating adhesive layer.

The present invention further provides a display device such as a liquid crystal display, organic EL display, or organic EL flexible display that includes a layer containing a cured product of the aforementioned UV-curable composition.

### DESCRIPTION OF THE PREFERRED EMBODIMENTS

A configuration of the present invention will be further described in detail below. The UV-curable composition of the present invention contains as essential curable components, when the total mass of the composition is 100 parts by mass:
(A) 1 to 99 parts by mass of a compound having one or more (meth)acryloxy group in one molecule; and
(B) 99 to 1 part by mass of an organopolysiloxane having two or more alkenyl groups and at least one aromatic hydrocarbon group with 6 to 20 carbon atoms in one molecule, and having no UV-curable functional group. Furthermore, the composition can contain a component selected from photoradical polymerization initiators and various additives, if necessary.

However, the curable composition of the present invention is characterized by being substantially free of an organic solvent.

In the present specification, the term “polysiloxane” refers to a siloxane unit (Si-O) with a degree of polymerization of two or more, in other words with an average of two or more Si—O bonds per molecule. Polysiloxanes include siloxane oligomers such as disiloxanes, trisiloxanes, tetrasiloxanes, and the like, as well as siloxane polymers with higher degrees of polymerization.

### [Component (A)]

Component (A) is a compound having one or more (meth)acryloxy group in one molecule. There is no limitation on the molecular structure so long as this objective can be achieved, and the structure can be linear, branched, cyclic, box-shaped, or any other type. In the present specification, “(meth)acryloxy group” refers to “a group selected from methacryloxy groups and acryloxy groups”. Compounds having a (meth)acryloxy group include both methacrylate compounds and acrylate compounds.

The viscosity of component (A) at 25° C. is preferably 1 to 1,000 mPa·s, more preferably 1 to 500 mPa·s, and particularly preferably 1 to 20 mPa·s.

Furthermore, component (A) contains, on average, 1 to 4, preferably 1 to 3, and more preferably 1 to 2 (meth)acryloxy groups per molecule. In compounds with a plurality of (meth)acryloxy groups, there is no limitation on the positions of the (meth)acryloxy groups in a molecule, and the groups may be close together or far apart.

The aforementioned component (A) may be a compound having one (meth)acryloxy group or a mixture of a compound having one (meth)acryloxy group and a compound having two or more (meth)acryloxy groups.

Furthermore, the compound having one (meth)acryloxy group in component (A) may be, and is preferably, (A1) one or more compound having one (meth)acryloxy group and no silicon atom, or a mixture thereof. Specifically, component (A) may be the following (A1) or (A2).
(A1) One type or more of a compound having one (meth) acryloxy group and having no silicon atom
(A2) A mixture of (A1) and one type or more of a compound having one (meth) acryloxy group and having a silicon atom
   Note that the mixture (A2) is a mixture of a compound having one (meth)acryloxy group and having a silicon atom (e.g., a (meth)acryloxy-functional polydimethylsiloxane, a (meth)acryloxy-functional branched organopolysiloxane, and the like) and a compound (A1) not having a silicon atom.

Furthermore, component (A) may contain at least one type of compound having an acryloxy group, or may be a mixture of two or more types of compounds having an acryloxy group.

Specific examples of compounds having one (meth)acryloxy group include isoamyl (meth)acrylate, octyl (meth)acrylate, dodecyl (meth)acrylate, lauryl (meth)acrylate, stearyl (meth)acrylate, diethylene glycol monoethyl ether (meth)acrylate, diethylene glycol monomethyl ether (meth)acrylate, 2-ethylhexyl (meth)acrylate, phenoxyethyl (meth)acrylate, diethylene glycol monophenyl ether (meth)acrylate, (meth)acrylic acids, 2-hydroxyethyl acrylate, 2-hydroxypropyl (meth)acrylate, 2-hydroxy-1-methylethyl (meth)acrylate, 2-hydroxy-3-phenoxypropyl (meth)acrylate, and 2-hydroxybutyl (meth)acrylate, 4-hydroxybutyl (meth)acrylate, 1-hydroxymethylpropyl (meth)acrylate, 4-(meth)acryloyloxyphenol, 6-hydroxyhexyl (meth)acrylate, methyl-2-(2-hydroxy-1-methylethyl) (meth)acrylate, tetrahydrofurfuryl (meth)acrylate, isobornyl (meth)acrylate, dicyclopentanyl (meth)acrylate, dicyclopentenyl (meth)acrylate, 3,3,5-trimethylcyclohexyl (meth)acrylate, one-terminal (meth)acryloxy-functional polydimethylsiloxane, one-terminal (meth)acryloxy-functional polydimethyldiphenylsiloxane copolymers, (meth)acryloxy-functional branched organopolysiloxane, and the like, and these may be used alone or in a mixture of two or more.

Examples of the (meth)acryloxy-functional branched organopolysiloxane include acryloxypropyl tristrimethylsiloxysilane, methacryloxypropyl tristrimethylsiloxysilane, acryloxypropyl tris (trimethylsilylethyldimethylsiloxy) silane, methacryloxypropyl tris (trimethylsilylethyldimethylsiloxy) silane, acryloxypropyl tris((tristrimethylsiloxysilyl) ethyldimethylsiloxy) silane, and methacryloxypropyl tris((tristrimethylsiloxysilyl) ethyldimethylsiloxy) silane. These may be used alone or in a combination of two or more.

Compounds with one (meth)acryloxy group can be used individually, or in combinations of two or more groups, in consideration of the viscosity of the compound, curability, hardness after curing, and the glass transition temperature. Of these, 2-ethylhexyl (meth)acrylate, isobornyl (meth)acrylate, dicyclopentanyl (meth)acrylate, and (meth)acryloxypropyl tristrimethylsiloxysilane are preferably used, and 2-ethylhexyl acrylate, isobornyl acrylate, dicyclopentanyl acrylate, and (meth)acryloxypropyl tristrimethylsiloxysilane are particularly preferably used.

Specific examples of compounds having two or more (meth)acryloxy groups include diethylene glycol di(meth)acrylate, triethylene glycol di(meth)acrylate, neopentyl glycol di(meth)acrylate, polyethylene glycol di(meth)acrylate, 1,4-bis(acryloyloxy)butane, 1,6-bis((meth)acryloyloxy)hexane, 1,9-bis(acryloyloxy)nonane, tricyclodecane dimethanol di(meth)acrylate, trimethylolpropane tri(meth)acrylate, tris(2-acryloyloxy)ethyl isocyanurate, pentaerythritol tetraacrylate, 3-acryloyloxy-2-hydroxypropyl methacrylate, 3-methacryloyloxy-2-hydroxypropyl methacrylate, 3-(meth)acryloyloxy-2-hydroxypropyl (meth)acrylate, glycerol di(meth)acrylate, glycerol-1,3-diglycerolate di(meth)acrylate, polydimethylsiloxane with (meth)acryloxy-functional groups on both terminals, polydimethyldiphenylsiloxane copolymers with (meth)acryloxy functional groups on both terminals, polydimethyl((meth)acryloxyalkylmethyl) siloxane copolymers with trimethylsilyl functional groups on both terminals, polydimethyl((meth)acryloxyalkylmethyl) siloxane copolymers with acryloxy functional groups on both terminals, and the like.

Compounds with two or more (meth)acryloxy groups can be used individually, or in combinations of two or more groups, in consideration the viscosity of the compound, curability, compatibility with the aforementioned compound having one acryloxy group, hardness after curing, and the glass transition temperature. Diethylene glycol di(meth)acrylate, 1,6-bis((meth)acryloyloxy) hexane, tricyclodecane dimethanol di(meth)acrylate, trimethylolpropane tri(meth)acrylate, pentaerythritol tetra(meth)acrylate, and polydimethylsiloxane with (meth)acryloxy functional groups on both terminals are preferably used, but it is more preferable to use a compound not having a silicon atom, in other words, diethylene glycol di(meth)acrylate, 1,6-bis((meth)acryloyloxy) hexane, tricyclodecane dimethanol di(meth)acrylate, trimethylolpropane tri(meth)acrylate, and pentaerythritol tetra(meth)acrylate.

Furthermore, in consideration of the aforementioned physical properties, the compound having two or more (meth)acryloxy groups can be used in combination with the compound having one (meth)acryloxy group. In this case, the two can be combined in at an arbitrary ratio, but usually, the ratio of [compound having two or more (meth)acryloxy groups]/[compound having one (meth)acryloxy group] is in the range of 1/99 to 75/25 (mass ratio), may be in the range of 1/99 to 50/50, and is preferably in the range of 1/99 to 30/70. This is because if the ratio of the compound having two or more (meth)acryloxy groups is too high, a cured product will tend to be hard and brittle.

### [Component (B)]

Component (B) is an organopolysiloxane having two or more alkenyl groups and at least one aromatic hydrocarbon group with 6 to 20 carbon atoms in one molecule, and having no UV-curable functional group. Such component (B) improves the viscosity in the entire substantially solvent-free type UV composition according to the present invention as well as the mechanical strength (particularly toughness and tensile elongation) of the cured product, and has an aryl group or other aromatic hydrocarbon group in a molecule, resulting in the advantage of not impairing the UV curability of the entire composition.

The alkenyl group in component (B) is preferably a terminal alkenyl group in the molecular structure thereof. In particular, component (B) having alkenyl groups at both molecular chain ends functions as a crosslinking agent and/or a chain extender in a crosslinked structure, and contributes to improving the rubber properties of the cured product, and particularly elongation and tensile strength.

The aforementioned component (B) can be a linear, branched, or cyclic organopolysiloxane expressed by the following average compositional formula:

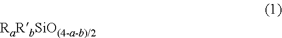

(where R represents an alkenyl group;
R′ represents a group selected from monovalent hydrocarbon groups excluding alkenyl groups as well as hydroxyl groups, and alkoxy groups; and
a and b are numbers satisfying the following conditions: 1≤a+b≤3 and 0.05≤a/(a+b)<1.0, there are at least two Rs in a molecule, and at least one of the R's is an aromatic hydrocarbon group with 6 to 20 carbon atoms.).

Examples of the alkenyl groups represented by R in formula (1) include alkenyl groups with 2 to 8 carbon atoms, and specifically vinyl groups, allyl groups, butenyl groups, pentenyl groups, hexenyl groups, and octenyl groups. Of these, vinyl groups and hexenyl group are particularly preferable.

At least one R′ is an aromatic hydrocarbon group with 6 to 20 carbon atoms, and the remainder are groups selected from monovalent hydrocarbon groups, hydroxyl groups, and alkoxy groups. In particular, examples of the aromatic hydrocarbon group with 6 to 20 carbon atoms represented by R′ include phenyl groups, tolyl groups, xylyl groups, naphthyl groups, and other groups, with the phenyl groups being preferred. If R′ does not include an aromatic hydrocarbon group with 6 to 20 carbon atoms, even if an organopolysiloxane containing an alkenyl group is used in place of component (B), the UV curability of the composition as a whole is significantly reduced, and thus it may not be possible to achieve the improvement in mechanical strength and favorable UV curability of the cured product according to the present invention.

Other monovalent hydrocarbon groups represented by R′ include unsubstituted monovalent hydrocarbon groups and fluorine-substituted monovalent hydrocarbon groups. The unsubstituted or fluorine-substituted monovalent hydrocarbon group is preferably a group selected from unsubstituted or fluorine-substituted alkyls and cycloalkyls with 1 to 20 carbon atoms. Examples of the alkyl groups above include methyl, ethyl, n-propyl, isopropyl, n-butyl, tert-butyl, sec-butyl, pentyl, hexyl, octyl, and other groups, but methyl groups and hexyl groups are particularly preferable. Examples of the cycloalkyl groups above include cyclopentyl, cyclohexyl, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group.

The organopolysiloxane expressed by the aforementioned formula (1) has a viscosity at 25° C. of 1 to 25,000 mPa·s, and more preferably 1 to 5,000 mPa·s. The viscosity of the organopolysiloxane can be adjusted by changing the ratio of a and b in formula (1) as well as the molecular weight.

The organopolysiloxane expressed by formula (1) preferably has, on average, 2 to 1,000 silicon atoms, and more preferably 2 to 500 silicon atoms per molecule.

In one preferred aspect, the organopolysiloxane of component (B) is a compound expressed by the following formula (2):

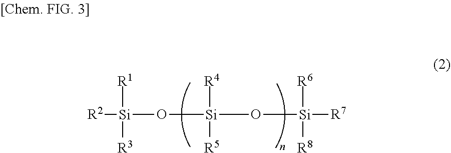

Similar to the compound expressed by formula (1) above, the organopolysiloxane expressed by formula (2) has at least two alkenyl groups and at least one aromatic hydrocarbon group with 6 to 20 carbon atoms in one molecule. The structure of the alkenyl group is not limited to an alkenyl group with a specific chemical structure so long as the structure has a carbon-carbon double bond. The alkenyl group is preferably a terminal alkenyl group, and examples thereof include, but are not limited to, alkenyl groups with 2 to 20 carbon atoms, such as vinyl groups, allyl groups, butenyl groups, pentenyl groups, hexenyl groups, heptenyl groups, octenyl groups, nonenyl groups, decenyl groups, undecenyl groups, dodecenyl groups, 4-vinylphenyl groups, and the like. Vinyl groups and hexenyl groups are particularly preferable. Examples of the aromatic hydrocarbon group with 6 to 20 carbon atoms include phenyl groups, tolyl groups, xylyl groups, naphthyl groups, and the like, with phenyl groups being preferable.

In formula (2), R¹ to R⁸ other than the alkenyl group and the aromatic hydrocarbon group with 6 to 20 carbon atoms are each independently a group selected from unsubstituted or fluorine-substituted monovalent hydrocarbon groups, preferably unsubstituted or fluorine-substituted alkyl groups with 1 to 20 carbon atoms, and cycloalkyls. Examples of the alkyl groups above include methyl, ethyl, n-propyl, isopropyl, n-butyl, tert-butyl, sec-butyl, pentyl, octyl, and other groups, and methyl groups are particularly preferable. Examples of the cycloalkyl groups above include cyclopentyl, cyclohexyl, and the like. Examples of fluorine-substituted monovalent hydrocarbon groups include 3,3,3-trifluoropropyl and 3,3,4,4,5,5,6,6,6-nonafluorohexyl groups. The 3,3,3-trifluoropropyl group is preferred as the fluorine-substituted monovalent hydrocarbon group.

In formula (2), n is a value in which the viscosity of the organopolysiloxane expressed by formula (2) at 25° C. is preferably 1 to 25,000 mPa·s, and more preferably 1 to 5,000 mPa·s. A person of ordinary skill in the art can easily determine the value of n without excess trial and error such that the viscosity of the organopolysiloxane of formula (2) is within the aforementioned viscosity range.

The number of alkenyl groups in the organopolysiloxane of formula (2), which is component (B), is 2 or more per molecule, preferably 2 or more and 10 or less, and more preferably 2 or more and 8 or less.

The organopolysiloxane of formula (2) can be used as one type or as a mixture of two or more types. If two or more organopolysiloxanes are used as a mixture, the viscosity of the mixture at 25° C. is preferably the viscosity described above.

Furthermore, the aforementioned compound of formula (1) may be a branched organopolysiloxane expressed by the following average unit formula (3).

### Average Unit Formula (3):

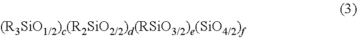

In formula (3), R each independently represents a group selected from alkenyl groups, unsubstituted or fluorine-substituted monovalent hydrocarbon groups, hydroxyl groups, and alkoxy groups, and of all Rs, at least two are alkenyl groups and at least one is an aromatic hydrocarbon group with 6 to 20 carbon atoms, (e+f) is a positive number, c is 0 or a positive number, and d is a number in the range of 0 to 100.

The alkenyl group, the aromatic hydrocarbon group with 6 to 20 carbon atoms, and the monovalent hydrocarbon group are as defined above for formula (2). Furthermore, a preferred viscosity of the organopolysiloxane expressed by formula (3) is as specified above for the organopolysiloxane expressed by formula (2). Furthermore, the alkoxy groups and silanol groups may remain in a molecule in small amounts.

The organopolysiloxane expressed by formula (3) preferably has 4 to 30, and particularly 6 to 20 silicon atoms per molecule.

The number of alkenyl groups in the organopolysiloxane expressed by formula (3) is, on average, 2 or more per molecule, and preferably 2 or more and 10 or less.

In one preferred aspect, component (B), and particularly the organopolysiloxane of formula (3), is a branched organopolysiloxane having a unit expressed by (RSiO_{3/2}).

Specific examples of the linear organopolysiloxanes expressed by formula (1), and particularly formula (2), include, but are not limited to, polymethylphenylsiloxane with dimethylvinylsilyl groups on both terminals, polydimethyl/methylphenylsiloxane copolymers with dimethylvinylsilyl groups on both terminals, polydimethyl/diphenylsiloxane copolymers with dimethylvinylsilyl groups on both terminals, polymethylphenylsiloxane with dimethylhexenylsilyl groups on both terminals, polydimethyl/methylphenylsiloxane copolymers with dimethylhexenylsilyl on groups both terminals, polydimethyl/diphenylsiloxane copolymers with dimethylhexenylsilyl groups on both terminals, polymethylphenyl/methylvinylsiloxane copolymers with trimethylsilyl groups on both terminals, polymethylphenyl/methylhexenylsiloxane copolymers with trimethylsilyl groups on both terminals, polymethylphenylsiloxane/methylhexenylsiloxane copolymers with trimethylsilyl groups on both terminals, polymethylphenylsiloxane with diphenylvinylsilyl groups on both terminals, polymethylphenylsiloxane with diphenylhexenylsilyl groups on both terminals, polydimethylsiloxane with methylphenylvinylsilyl groups on both terminals, 1,3-dimethyl-1,3-diphenyl-1,3-divinyldisiloxane, and the like.

Specific examples of the branched organopolysiloxane expressed by formula (1), and particularly formula (3), include, but are not limited to, polysiloxanes containing an M^{Vi} (dimethylvinylsiloxy) unit and T^{Ph} (phenylsiloxy) unit, polysiloxanes containing an M^{Vi} unit, M (trimethylsilyl) unit and T^{Ph} (phenylsiloxy) unit, polysiloxanes containing an M^{Vi} unit, D (dimethylsiloxy) unit and T^{Ph} unit, polysiloxanes containing an M^{Hex} (dimethylhexenylsiloxy) unit and T^{Ph} unit, polysiloxanes containing an M^{Hex} unit, M unit and T^{Ph} unit, polysiloxanes containing an M^{Hex} unit, D unit and T^{Ph} unit, polysiloxanes containing an M unit, D^{Vi} (methylvinylsiloxy) unit and T^{Ph} unit, polysiloxanes containing a D^{Vi} unit, D unit and T^{Ph} unit, polysiloxanes containing a D^{Vi} unit and T^{Ph} unit, polysiloxanes containing an M unit, D^{Hex} (methylhexenylsiloxy) unit and T^{Ph} unit, polysiloxanes containing a D^{Hex} unit, D unit and T^{Ph} unit, polysiloxanes containing a D^{Hex} unit and T^{Ph} unit, polysiloxanes containing a T^{Hex} unit and T^{Ph} unit, polysiloxanes containing an M unit, T^{Hex} unit and T^{Ph} unit, and the like.

Furthermore, the compound of the aforementioned formula (1) may be a cyclic organopolysiloxane expressed by the following formula (4):

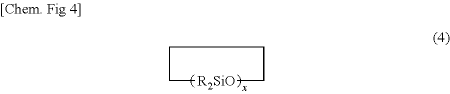

(where R each independently represents a group selected from alkenyl groups and unsubstituted or fluorine-substituted monovalent hydrocarbon groups, x is an integer from 3 to 10, and at least two alkenyl groups and at least one aromatic hydrocarbon group with 6 to 20 carbon atoms are present in a molecule).

The alkenyl group, aromatic hydrocarbon group with 6 to 20 carbon atoms, and unsubstituted or fluorine-substituted monovalent hydrocarbon group that can be represented by R in formula (4) are as defined above for formula (1).

Furthermore, a preferred viscosity of the organopolysiloxane expressed by formula (4) is as specified above for the organopolysiloxane expressed by formula (1).

Specific examples of cyclic organopolysiloxanes expressed by formula (4) include cyclic trisiloxanes containing a methylvinylsiloxy group and methylphenylsiloxy group, and cyclic tetrasiloxanes containing a methylvinylsiloxy group and methylphenylsiloxy group.

The organopolysiloxanes expressed by the aforementioned formula (1), and more specifically any of formulas (2) to (4), can each be individually one type, or an arbitrary combination of two or more types as component (B).

Component (B) is particularly preferably one or more organopolysiloxane selected from the group consisting of the aforementioned organopolysiloxanes expressed by formula (2), branched organopolysiloxanes expressed by formula (3), and combinations thereof. Particularly preferred is an organopolysiloxane expressed by the aforementioned formula (2), in which R² and R⁷ at both molecular chain ends are alkenyl groups, at least one of the other substitution groups (R¹, R³, R⁴, R⁵, R⁶, and R⁸) is an aromatic hydrocarbon group with 6 to 20 carbon atoms, and n in formula (2) is a value such that the viscosity of the organopolysiloxane expressed by formula (2) at 25° C. is preferably 1 to 25,000 mPa·s, and more preferably 1 to 5,000 mPa·s.

Compounds recommended as component (B) are one compound or a combination of two or more compounds, selected from the group consisting of: polymethylphenylsiloxane with dimethylvinylsilyl groups on both terminals, polydimethyl/methylphenylsiloxane copolymers with dimethylvinylsilyl groups on both terminals, polydimethyl/diphenylsiloxane copolymers with dimethylvinylsilyl groups on both terminals, polymethylphenylsiloxane with dimethylhexenylsilyl groups on both terminals, polydimethyl/methylphenylsiloxane copolymers with dimethylhexenylsilyl groups on both terminals, polymethylphenyl/methylvinylsiloxane copolymers with trimethylsilyl groups on both terminals, polymethylphenyl/methylhexenylsiloxane copolymers with trimethylsilyl groups on both terminals, polydimethylsiloxane with methylphenylvinylsilyl groups on both terminals, 1,3-dimethyl-1,3-diphenyl-1,3-divinyldisiloxane, polysiloxanes containing an M unit, D^{Vi} unit, and T^{Ph} unit, polysiloxanes containing an M^{Vi} unit and T^{Ph} unit, polysiloxanes containing an M^{Vi} unit, D unit, and T^{Ph} unit, polysiloxanes containing an M unit, D^{Hex} unit, and T^{Ph} unit, polysiloxanes containing an M^{Hex} unit and T^{Ph} unit, polysiloxanes containing an M^{Hex} unit, D unit and T^{Ph} unit, and polysiloxanes containing a T^{Hex} unit and T^{Ph} unit. Of these, polymethylphenylsiloxane with dimethylvinylsilyl groups on both terminals, polydimethyl/diphenylsiloxane copolymers with dimethylvinylsilyl groups on both terminals, polysiloxanes containing an M unit, D^{Hex} unit, and T^{Ph} unit, polysiloxanes containing a D^{Hex} unit and T^{Ph} unit, and polysiloxanes containing a T^{Hex} unit and T^{Ph} unit are particularly preferably used.

### [Mixing Ratio of Components (A)/(B)]

The mixing ratio of component (A) and component (B) is in the range of 1 to 99 mass % for component (A) and 99 to 1 mass % for component (B), relative to 100 mass % of the total amount of component (A) and component (B). When the ratio of components (A) and (B) is within this range, a material can be designed where the viscosity of the curable composition will be appropriate, favorable UV curability is maintained, and the mechanical properties of the resulting cured product, and particularly tensile elongation, will be favorable. The hardness of the cured product can easily be designed to be high by increasing the ratio of component (A). The ratio of component (A) is preferably 15 mass % or more and 85 mass % or less, and more preferably 25 mass % or more and 75 mass % or less, of the total amount of components (A) and (B).

The amount of component (A) and component (B) in the UV-curable composition of the present invention are in the aforementioned amount ranges, but when the total mass of the composition is 100 parts by mass, the sum of the amount of component (A) and component (B) is preferably 90 parts by mass or more, and particularly preferably in the range of 90 to 99.9 parts by mass or in the range of 90 to 99 parts by mass. In other words, a suitable UV-curable composition is a composition mostly containing component (A) and component (B). However, the present composition may contain another component to be described later.

### [No Use of Organic Solvent]

The UV-curable composition of the present invention can achieve a suitable viscosity for the aforementioned coating agent without substantial use of an organic solvent, and by using each of the aforementioned components, the UV-curable composition substantially does not include an organic solvent. In the present specification, the phrase “substantially free of an organic solvent” means that the amount of organic solvent is less than 0.1 mass % of the total composition, preferably less than or equal to the analytical limit of analytical methods such as gas chromatography or the like. In the present invention, the desired viscosity can be achieved without the use of organic solvents by adjusting the molecular structure and molecular weight of component (A) and component (B).

In addition to the components (A) and (B) above, a photopolymerization initiator can be added to the UV-curable composition of the present invention if desired. A photoradical polymerization initiator can be used as the photopolymerization initiator. The photoradical polymerization initiator generates free radicals by irradiating UV rays or electron beams, which trigger a radical polymerization reaction, to cure the composition of the present invention. When the composition of the present invention is cured by electron beam irradiation, a polymerization initiator is normally not required.

The photoradical polymerization initiators are known to be broadly classified into photocleaving and hydrogen extracting types. However, the photoradical polymerization initiator used in the composition of the present invention can be selected arbitrarily from those known in the technical field, and is not limited to any particular one. Examples of photoradical polymerization initiators include, but are not limited to, acetophenone, p-anisyl, benzyl, benzoin, benzophenone, 2-benzoylbenzoic acid, 4,4′-bis(diethylamino)benzophenone, 4,4′-bis(dimethylamino)benzophenone, benzoin methyl ether, benzoin isopropyl ether, benzoin isobutyl ether, benzoin ethyl ether, 4-benzoylbenzoic acid, 2,2′-bis(2-chlorophenyl)-4,4′5,5′-tetraphenyl-1,2′-biimidazole, methyl 2-benzoylbenzoate, 2-(1,3-benzodioxol-5-yl)-4,6-bis(trichloromethyl)-1,3,5-triazine, 2-benzyl-2-(dimethylamino)-4′-morpholinobutyrophenone, (±)-camphorquinone, 2-chlorothioxanthone, 4,4′-dichlorobenzophenone, 2,2-diethoxyacetophenone, 2,2-dimethoxy-2-phenylacetophenone, 2,4-diethylthioxanthene-9-one, diphenyl (2,4,6-trimethylbenzoyl)phosphine oxide, ethyl(2,4,6-trimethylbenzoyl)phenyl phosphinate, 1,4-dibenzoylbenzene, 2-ethylanthraquinone, 1-hydroxycyclohexylphenyl ketone, 2-hydroxy-2-methylpropiophenone, 2-hydroxy-4′-(2-hydroxyethoxy)-2-methylpropiophenone, 2-isopropylthioxanthone, lithium phenyl (2,4,6-trimethylbenzoyl) phosphinate, 2-methyl-4′-(methylthio)-2-morpholinopropiophenone, 2-isonitrosopropiophenone, 2-phenyl-2-(p-toluenesulfonyloxy) acetophenone, and phenylbis(2,4,6-trimethylbenzoyl)phosphine oxide, and the like. Furthermore, in addition to the aforementioned compounds, examples of the photoradical polymerization initiators can include Omnirad (registered trademark) 651, 184, 1173, 2959, 127, 907, 369, 369E, and 379EG (alkylphenone photopolymerization initiators, IGM Resins B.V.); Omnirad (registered trademark) TPO H, TPO-L, and 819 (acyl phosphine oxide photopolymerization initiators, IGM Resins B.V.); Omnirad (registered trademark) MBF and 754 (intramolecular hydrogen extracting type photopolymerization initiators, IGM Resins B.V.); Irgacure (registered trademark) OXE01 and OXE02 (oxime ester non-associative polymerization initiator, BASF); and the like.

While the amount of the photoradical polymerization initiator added to the composition of the present invention is not particularly limited so long as the intended photopolymerization reaction or photocuring reaction occurs, it is generally used at an amount of 0.01 to 5 mass %, and preferably 0.05 to 1 mass % relative to the total mass of the composition of the present invention.

Furthermore, a photosensitizer may be used in combination with the aforementioned photoradical polymerization initiator. Use of a sensitizer can increase the photon efficiency of the polymerization reaction, and is particularly effective when the coating thickness of the composition is relatively thick or when a relatively long-wavelength LED light source is used, because use of longer wavelength light for the polymerization reaction compared to only using a photoinitiator is feasible. While not limited thereto, examples of known sensitizers include anthracene-based compounds, phenothiazine-based compounds, perylene-based compounds, cyanine-based compounds, melocyanine-based compounds, coumarin-based compounds, benzylidene ketone-based compounds, and (thio)xanthene- or (thio)xanthone-based compounds such as isopropylthioxanthone, 2,4-diethylthioxanthone, alkyl-substituted anthracenes, squarylium-based compounds, (thia)pyrylium-based compounds, porphyrin-based compounds, and the like, with an arbitrary photosensitizer capable of being used in the curable composition according to the present invention.

A cured product obtained from the curable composition of the present invention can be designed such that the desired physical properties of the cured product and the curing rate of the curable composition are obtained and the viscosity of the curable composition is a desired value, in accordance with molecular chain lengths and molecular structures of components (A) and (B), the number of (meth)acryloxy groups per molecule of component (A), and the number of alkenyl groups per molecule of component (B). Furthermore, the cured product obtained by curing the curable composition of the present invention is also included in the scope of the present invention. Furthermore, the shape of the cured product obtained from the composition of the present invention is not particularly limited, and it may be a thin-film coating layer or adhesive layer, may be a sheet-like molded product or the like, may be injected into a specific site in an uncured state and then cured to form a filling material, or may be used as a sealing material for a laminate body, display device, or the like or as an intermediate layer. Cured products obtained from the composition of the present invention are preferably in the form of injection molded protective/adhesive layers and thin-film coating layers, and are particularly preferably thin-film insulating coating layers or adhesive layers.

The curable composition of the present invention is suitably used as a coating agent, potting agent, or adhesive, and particularly as an insulating coating agent, insulating adhesive, or potting agent for electronic and electrical devices.

The cured product obtained by curing the curable composition of the present invention is characterized by excellent mechanical properties, and particularly tensile properties. By optimizing the curable composition, it is possible to achieve a tensile elongation of the cured product of 100% or more when evaluated at 25° C. and a tensile rate of 50 mm/min using a test body with a thickness of 0.5 mm, making the composition useful as a layer-forming material for a flexible display.

If desired, the cured product obtained by curing the curable composition of the present invention can be designed to have a dielectric constant of less than 3.0, or less than 2.8, or the like, and the curable composition of the present invention can also be used to form a coating layer having a low dielectric constant.

If the curable composition of the present invention is used as an injection molding material or a coating agent, in order to provide the composition with suitable fluidity and workability for application to a base material, it is recommended that the viscosity of the entire composition be 500 mPa·s or less at 25° C., as measured using an E-type viscometer. When used as an injection molding material, the viscosity is preferably 200 mPa·s or less, and particularly 80 mPa·s or less, but is dependent on the gap into which the material is to be injected. On the other hand, when used as a coating agent, the preferred viscosity range is 5 to 60 mPa·s, more preferably 5 to 30 mPa·s, and particularly 5 to 20 mPa·s, considering application by the inkjet printing method, which is rapidly becoming more practical. The viscosity of the entire curable composition can be adjusted to the desired viscosity by using compounds with a preferred viscosity as each component so that the viscosity of the entire composition has the desired viscosity.

### <Other Additives>

In addition to the aforementioned components, additional additives may be added to the composition of the present invention if desired. Examples of additives include, but are not limited to, those described below.

### [Adhesion-Imparting Agent]

An adhesion promoter can be added to the composition of the present invention to improve adhesion and close-fitting properties to a base material in contact with the composition. When the curable composition of the present invention is used for applications such as coating agents, sealing materials, and the like that require adhesion or close-fitting properties to a base material, an adhesion-imparting agent is preferably added to the curable composition of the present invention. An arbitrary known adhesion promoter can be used, so long as the adhesion promoter does not interfere with a curing reaction of the composition of the present invention.

Examples of such adhesion promoters that can be used in the present invention include: organosilanes having a trialkoxysiloxy group (such as a trimethoxysiloxy group or a triethoxysiloxy group) or a trialkoxysilylalkyl group (such as a trimethoxysilylethyl group or triethoxysilylethyl groups) and a hydrosilyl group or an alkenyl group (such as a vinyl group or an allyl group), or organosiloxane oligomers having a linear structure, branched structure, or cyclic structure with approximately 4 to 20 silicon atoms; organosilanes having a trialkoxysiloxy group or a trialkoxysilylalkyl group and a methacryloxyalkyl group (such as a 3-methacryloxypropyl group), or organosiloxane oligomers having a linear structure, branched structure, or cyclic structure with approximately 4 to 20 silicon atoms; organosilanes having a trialkoxysiloxy group or a trialkoxysilylalkyl group and an epoxy group-bonded alkyl group (such as a 3-glycidoxypropyl group, a 4-glycidoxybutyl group, a 2-(3,4-epoxycyclohexyl) ethyl group, or a 3-(3,4-epoxycyclohexyl) propyl group), or organosiloxane oligomers having a linear structure, branched structure, or cyclic structure with approximately 4 to 20 silicon atoms; organic compounds having two or more trialkoxysilyl groups (such as trimethylsilyl groups or triethoxysilyl groups); reaction products of aminoalkyltrialkoxysilane and epoxy group-bonded alkyltrialkoxysilane, and epoxy group-containing ethyl polysilicate. Specific examples thereof include vinyl trimethoxysilane, allyl trimethoxysilane, allyl triethoxysilane, hydrogen triethoxysilane, 3-glycidoxypropyl trimethoxysilane, 3-glycidoxypropyl triethoxysilane, 2-(3,4-epoxycyclohexyl) ethyl trimethoxysilane, 3-methacryloxypropyl trimethoxysilane, 3-methacryloxypropyl triethoxysilane, 1,6-bis (trimethoxysilyl) hexane, 1,6-bis (triethoxysilyl) hexane, 1,3-bis [2-(trimethoxysilyl) ethyl]-1, 1,3,3-tetramethyldisiloxane, reaction products of 3-glycidoxypropyl triethoxysilane and 3-aminopropyl triethoxysilane, condensation reaction products of a methylvinyl siloxane oligomer blocked with a silanol group and a 3-glycidoxypropyl trimethoxysilane, condensation reaction products of a methylvinyl siloxane oligomer blocked with a silanol group and a 3-methacryloxypropyl triethoxysilane, and tris (3-trimethoxysilylpropyl) isocyanurate.

The amount of the adhesion promoter to be added to the curable composition of the present invention is not particularly limited. However, since it does not promote curing properties of the curable composition or discoloration of a cured product, the amount is preferably within a range of 0.01 to 5 parts by mass, or within a range of 0.01 to 2 parts by mass, relative to a total of 100 parts by mass of components (A) and (B).

### [Additional Optional Additives]

Another additive may be added to the composition of the present invention in addition to or in place of the adhesion-imparting agent described above, if desired. Examples of additives that can be used include leveling agents, silane coupling agents not included in those listed above as adhesion-imparting agents, UV absorbers, antioxidants, polymerization inhibitors, fillers (reinforcing fillers, insulating fillers, thermally conductive fillers, and other functional fillers), and the like. If necessary, an appropriate additive can be added to the composition of the present invention. Furthermore, a thixotropy-imparting agent may also be added to the composition of the present invention, if necessary, particularly when used as a potting agent or sealing material.

### [Application]

When the UV-curable organopolysiloxane composition of the present invention is irradiated with a high-energy beam, such as UV rays or the like, a radical polymerization reaction can proceed and a cured product can be formed.

Examples of available high-energy beams include UV rays, gamma rays, X-rays, alpha rays, electron beams, and the like. In particular, examples include UV rays, X-rays, and electron beams irradiated from a commercially available electron beam irradiating device. Of these, UV rays are preferable from the perspective of efficiency of catalyst activation, and UV rays within a wavelength range of 280 to 405 nm are preferable from the perspective of industrial use. Furthermore, the irradiation amount of UV rays is preferably within the range of 100 mJ/cm² to 10 J/cm² in terms of the cumulative irradiation amount at a wavelength of 365 nm or 405 nm.

Specifically, the curable composition of the present invention has high viscosity adjustability, and thus is particularly useful as a material for forming an insulating layer for various articles, and particularly electronic and electrical devices. The composition of the present invention can be applied to a base material or sandwiched between two base materials, at least one of which includes a material that allows UV rays or an electron beam to pass, and the composition can be cured by irradiating UV rays or an electron beam to form an insulating layer. In this case, the composition of the present invention can be patterned when applied to a base material, and then the composition can be cured. Alternatively, the composition can be applied to a base material, and cured and uncured portions can be left during curing by UV ray or electron beam irradiation. Thereafter, an uncured portion can be removed with a solvent to form an insulating layer having a desired pattern. In particular, when the cured layer according to the present invention is an insulating layer, the layer can be designed to have a low dielectric constant of less than 3.0.

The curable composition of the present invention provides favorable transparency of the cured product obtained therefrom, and is particularly suitable as a material for forming an insulating layer for touch panels, displays and other display devices. In this case, an arbitrary desired pattern may be formed as described above if necessary on the insulating layer. Therefore, a display device such as touch panel, display, or the like containing an insulating layer obtained by curing the UV-curable organopolysiloxane composition of the present invention is also an aspect of the present invention.

Furthermore, the curable composition of the present invention can also be used to form an insulating coating layer (insulating film) or adhesive layer by curing after coating an article. Therefore, the composition of the present invention can be used as an insulating coating agent or insulating adhesive. Furthermore, a cured product formed by curing the curable composition of the present invention can be used as an insulating coating layer or insulating adhesive layer.

An insulating film formed from the curable composition of the present invention can be used for various applications. In particular, use is possible as a structural member of an electronic device or as a material used in a process of manufacturing the electronic device. Electronic devices include semiconductor devices, magnetic recording heads, and other electronic apparatuses. For example, the curable composition of the present invention can be used in an insulating film of a semiconductor device, such as an LSI, system LSI, DRAM, SDRAM, RDRAM, D-RDRAM, or a multi-chip module multilayer circuit board, an interlayer insulating film for a semiconductor, an etching stopper film, a surface protection film, a buffer coating film, a passivation film in LSI, a cover coating for a flexible copper-clad plate, a solder resist film, and a surface-protecting film for an optical device.

Furthermore, the UV-curable composition of the present invention can be used as a potting agent in addition to a coating agent or adhesive, and particularly as an insulating potting agent for electronic and electrical devices.

The composition of the present invention can provide a low-viscosity composition by adjusting the mixing ratio of component (A) and component (B), and thus can be used as a material for forming a coating layer on a surface of a base material, and particularly by using an inkjet printing method.

The present invention is further described below on the basis of Examples, but the present invention is not limited to the Examples below.

### EXAMPLES

The UV-curable composition of the present invention and a cured product thereof of the present invention will be described below in further detail using examples. Furthermore, measurements and evaluations in the Examples and Comparative Examples were conducted as follows.

### [Viscosity of Curable Composition and Each Component]

The viscosity (mPa·s) of the composition at 25° C. was measured using a rotary viscometer (E-type viscometer VISCONIC EMD manufactured by TOKIMEC INC.).

### [Appearance of Curable Composition and Cured Product Obtained Therefrom]

The curable composition and the cured product obtained therefrom were visually observed to evaluate the appearance including transparency.

### [Preparation of Curable Composition]

Each material at the amounts listed in Table 1 below was placed in a brown plastic container and mixed well, using a planetary mixer to prepare the curable composition.

### [Curing of Curable Composition and Preparation of Tensile Test Piece]

Approximately 0.2 g of curable composition was injected between two glass substrates with a 0.5 mm thick spacer interpose therebetween. By irradiating LED light having a wavelength of 405 nm at an energy intensity of 2 J/cm² from the outside through one glass substrate, the composition was cured to prepare a plate-shaped cured product having a length of 50 mm and a thickness of 0.5 mm. The short pieces were trisected to prepare 10×50×0.5 (thick) mm³ strip-shaped tensile test pieces.

### [Tensile Properties of Organopolysiloxane Cured Product]

Tensile test pieces prepared from the aforementioned organopolysiloxane cured product were evaluated at a testing rate of 50 mm/min at 25° C. using an Autograph AGS-X manufactured by Shimadzu Corporation. Elongation at break (units: %) was recorded as the measured value.

### [Elastic Modulus of Organopolysiloxane Cured Product]

From the stress-strain curve obtained in a tensile test of the organopolysiloxane cured product, the elastic modulus (Young's modulus) (unit: MPa) was calculated from the slope between two points where the strain was from 0% to 5%.

### [Curing of Curable Composition and Preparation of Sample for Dielectric Constant Measurement]

A metal die having a thickness of 1 mm having circular holes with an inner diameter of 40 mm was placed on a PET film coated with a fluoropolymer release agent, and approximately 1.3 g of the curable composition was poured into a hole thereof. A PET film similar to that described above was placed over the composition, and a 10 mm thick glass plate was placed thereon. By irradiating an LED light having a wavelength of 405 nm at an energy intensity of 2 J/cm² from above, the composition was cured to prepare a disk-shaped organopolysiloxane cured product having a diameter of 40 mm and a thickness of 1 mm.

### [Dielectric Constant of Organopolysiloxane Cured Product (Example 1)]

A tin foil having a diameter of 33 mm and a thickness of 0.007 mm was pressed onto both surfaces of the prepared organopolysiloxane cured product. In order to improve close-fitting properties between the cured product and the foil, a small amount of silicone oil, if necessary, was used for pressing. The capacitance at room temperature and 100 KHz was measured by an E4990A precision impedance analyzer manufactured by Keysight Technologies to which a parallel plate electrode having a diameter of 30 mm was connected. The dielectric constant was calculated using measured capacitance values, separately measured thicknesses of the cured product, and electrode area values. The dielectric constant of the organopolysiloxane cured product in Example 1 shown in the table below was 2.8, indicating that a cured product with a low dielectric constant was obtained.

### EXAMPLES AND COMPARATIVE EXAMPLES

The UV-curable compositions were prepared at the compositions (parts by mass) shown in Table 1 and Table 2 using each of the following components.
(A1) Isobornyl acrylate (monofunctional)
(A2) Isobornyl methacrylate (monofunctional)
(A3) 2-Ethylhexyl acrylate (monofunctional)
(A4) Tricyclodecane dimethanol dimethacrylate (bifunctional)
(A5) Trimethylolpropane triacrylate (trifunctional)
(A6) Light acrylate PDMS-DA30 (manufactured by Nagase & Co., Ltd.: bifunctional)
(A7) Methacryloxypropyl trimethylsiloxysilane (monofunctional)
(B1) Polyphenylmethylsiloxane blocked at both ends with dimethylvinylsiloxy groups (amount of vinyl groups: 1.5 mass %, amount of phenyl groups: 41 mol %; viscosity: 3,000 mPa·s)
(B2) Polydimethyl/diphenylsiloxane copolymer blocked at both ends with dimethylvinylsiloxy groups (amount of vinyl groups: 0.2 mass %, amount of phenyl groups: 20 mol %; viscosity: 13,000 mPa·s)
(B3) Dimethyldivinyldiphenyldisiloxane (amount of vinyl groups: 17.4 mass %, amount of phenyl groups: 33 mol %; viscosity: 20 mPa·s)
(b) Dimethylvinyl polydimethylsiloxane blocked at both ends (amount of vinyl groups: 0.4%; viscosity: 500 mPa·s)
(C1) 2,4,6-trimethylbenzoyldiphenylphosphine oxide (product name: Omnirad TPO-L, manufactured by IGM Resins Co., Ltd.)
(C2) OMNIRAD TPO-L (manufactured by IGM Resins)
(C3) Dibutylhydroxytoluene

TABLE 1

| Component | Example 1 | Example 2 | Example 3 | Example 4 | Example 5 | Example 6 | Example 7 |
|---|---|---|---|---|---|---|---|
| (A1) | 65.0 | | 34.2 | 83.8 | | 54.9 | 58.2 |
| (A2) | | 65.0 | | | | 10.0 | |
| (A3) | | | | | | | 15.2 |
| (A4) | | | | | 54.2 | | |
| (B1) | 34.2 | 34.2 | 65.0 | | 45.0 | 34.3 | 25.8 |
| (B2) | | | | 15.4 | | | |
| (C1) | 0.5 | | 0.5 | 0.5 | | | 0.5 |
| (C2) | | 0.5 | | | 0.5 | 0.5 | |
| (C3) | 0.3 | 0.3 | 0.3 | 0.3 | 0.3 | 0.3 | 0.3 |
| Total | 100.0 | 100.0 | 100.0 | 100.0 | 100.0 | 100.0 | 100.0 |
| Silicon- | 34 | 34 | 65 | 15 | 45 | 34 | 26 |
| containing | | | | | | | |
| component in | | | | | | | |
| composition | | | | | | | |
| (mass %) | | | | | | | |
| Appearance | Transparent | Transparent | Transparent | Transparent | Transparent | Transparent | Transparent |
| of curable | | | | | | | |
| composition | | | | | | | |
| Viscosity of | 32 | 31 | 158 | 49 | 362 | 31 | 14 |
| composition | | | | | | | |
| (mPa · s) | | | | | | | |
| Appearance | Transparent | Transparent | Transparent | Translucent | Transparent | Transparent | Transparent |
| of cured | | | | | | | |
| product | | | | | | | |
| Tensile | 330 | <10 | >500 | <10 | <10 | 170 | >500 |
| elongation at | | | | | | | |
| break of | | | | | | | |
| cured | | | | | | | |
| product (%) | | | | | | | |
| Elastic | 100 | 6.4 | 15 | 16 | 280 | 190 | 22 |
| modulus of | | | | | | | |
| cured | | | | | | | |
| product | | | | | | | |
| (MPa) | | | | | | | |

TABLE 2

| | Example | Example | Example | Example | Example | Comparative | Comparative |
|---|---|---|---|---|---|---|---|
| Component | 8 | 9 | 10 | 11 | 12 | Example 1 | Example 2 |
| (A1) | 54.9 | 55.2 | 67.5 | 62.5 | 65.4 | | |
| (A2) | | | | | | | 25.0 |
| (A3) | 14.8 | 14.5 | | | | | |
| (A4) | 5.0 | | | | | | |
| (A5) | | 5.0 | | | | | |
| (A6) | | | 5.0 | | | | |
| (A7) | | | | 10.0 | | | |
| (B1) | 24.5 | 24.5 | 26.7 | 26.7 | 27.0 | 99.2 | |
| (B3) | | | | | 6.8 | | |
| (b) | | | | | | | 74.2 |
| (C1) | 0.5 | 0.5 | 0.5 | 0.5 | 0.5 | | |
| (C2) | | | | | | 0.5 | 0.5 |
| (C3) | 0.3 | 0.3 | 0.3 | 0.3 | 0.3 | 0.3 | 0.3 |
| Total | 100.0 | 100.0 | 100.0 | 100.0 | 100.0 | 100.0 | 100.0 |
| Silicon-containing | 25 | 25 | 32 | 37 | 34 | 99 | 74 |
| component in | | | | | | | |
| composition (mass %) | | | | | | | |
| Appearance of | Transparent | Transparent | Transparent | Transparent | Transparent | Transparent | Transparent |
| curable composition | | | | | | | |
| Viscosity of | 15 | 15 | 25 | 21 | 22 | 2387 | 200 |
| composition (mPa · s) | | | | | | | |
| Appearance of cured | Transparent | Transparent | Translucent | Transparent | Transparent | Did not | Did not |
| product | | | | | | cure | cure |
| Tensile elongation at | 240 | 150 | 130 | 305 | 335 | — | — |
| break of cured | | | | | | | |
| product (%) | | | | | | | |
| Elastic modulus of | 60 | 140 | 360 | 270 | 240 | — | — |
| cured product (MPa) | | | | | | | |

As shown in Tables 1 and 2, the UV-curable compositions (Examples 1 to 12) of the present invention are solvent-free, and the viscosity and the tensile elongation of cured products can be easily adjusted by adjusting the type and number of functional groups of component (A) or the mixing ratio of component (A) and component (B). In particular, when a composition contains a low-viscosity component (A), the composition has a viscosity at 25° C. that is suitable for use as an injection molding material and for applying to a base material as a coating agent, and particularly application by inkjet printing, and the obtained cured product has high transparency. Furthermore, as indicated in Example 1, a cured product obtained from the composition of the present invention exhibited low dielectric properties.

On the other hand, in the case of a composition not containing component (A) (Comparative Example 1) and a composition in which component (B) does not have an aromatic hydrocarbon group with 6 to 20 carbon atoms (Comparative Example 2), the UV curability was insufficient, and it was difficult to obtain a cured product under industrial standard curing conditions.

### INDUSTRIAL APPLICABILITY

The UV-curable composition of the present invention is particularly suitable for the applications described above, and particularly as a material for forming an insulating layer for touch panels and displays and other display devices, and particularly flexible displays.

1. A UV-curable composition, comprising, when the total mass of the composition is 100 parts by mass:
(A) 1 to 99 parts by mass of a compound having one or more (meth)acryloxy group in one molecule; and
(B) 99 to 1 part by mass of an organopolysiloxane having two or more alkenyl groups and at least one aromatic hydrocarbon group with 6 to 20 carbon atoms in one molecule, and having no UV-curable functional group;
wherein the composition is substantially free of an organic solvent.

2. The UV-curable composition according to claim 1, wherein the viscosity of the entire composition, as measured at 25° C. using an E-type viscometer, is 500 mPa·s or less.

3. The UV-curable composition according to claim 1, wherein component (B) is a linear, branched, or cyclic organopolysiloxane expressed by the average compositional formula: 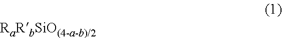
where R represents an alkenyl group;
R′ represents a group selected from monovalent hydrocarbon groups excluding alkenyl groups as well as hydroxyl groups, and alkoxy groups; and
a and b are numbers satisfying the following conditions: 1≤a+b≤3 and 0.05≤a/(a+b)<1.0, there are at least two Rs in a molecule, and at least one of the R's is an aromatic hydrocarbon group with 6 to 20 carbon atoms.

4. The UV-curable composition according to claim 1, wherein the organopolysiloxane of component (B) is one type or more of an organopolysiloxane having at least two alkenyl groups and one or more aromatic hydrocarbon group with 6 to 20 carbon atoms, the organopolysiloxane being selected from the group consisting of:
organopolysiloxanes expressed by the following formula (2): 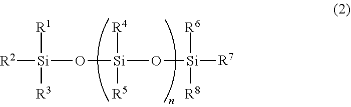
(where of all of R¹ to R⁸ groups, at least two alkenyl groups are present in a molecule; at least one aromatic hydrocarbon group with 6 to 20 carbon atoms is present in a molecule; the remaining R¹ to R⁸ each independently represent an unsubstituted or fluorine-substituted monovalent hydrocarbon group, a hydroxyl group, or an alkoxy group; and n is a numerical value of 0 or more and 1,000 or less);
branched organopolysiloxanes expressed by average unit formula (3): 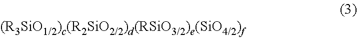
where R each independently represents a group selected from alkenyl groups, unsubstituted or fluorine-substituted monovalent hydrocarbon groups, hydroxyl groups, and alkoxy groups, and of all Rs, at least two are alkenyl groups and at least one is an aromatic hydrocarbon group with 6 to 20 carbon atoms, (e+f) is a positive number, c is 0 or a positive number, and d is a number in the range of 0 to 100;
cyclic organopolysiloxanes expressed by the following formula (4): 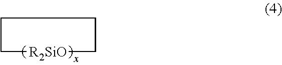
where R each independently represents a group selected from alkenyl groups and unsubstituted or fluorine-substituted monovalent hydrocarbon groups, x is an integer from 3 to 10, and at least two alkenyl groups and at least one aromatic hydrocarbon group with 6 to 20 carbon atoms are present in a molecule; and
mixtures of these organopolysiloxanes.

5. The UV-curable composition according to claim 4, claim 1, wherein component (B) includes a linear organopolysiloxane expressed by the aforementioned formula (2).

6. The UV-curable composition according to claim 1, wherein component (A) is a compound having one (meth)acryloxy group or a mixture of a compound having one (meth)acryloxy group and a compound having two or more (meth)acryloxy groups.

7. The UV-curable composition according to claim 1, wherein the compound having one (meth)acryloxy group in component (A) is the following (A1) or (A2):
(A1) one or more types of a compound having one (meth)acryloxy group and having no silicon atom;
(A2) a mixture of (A1) and one type or more types of a compound having one (meth)acryloxy group and having a silicon atom.

8. The UV-curable composition according to claim 1, wherein component (A) includes a compound having at least one type of acryloxy group.

9. The UV-curable composition according to claim 1, wherein the amount of aromatic hydrocarbon groups with 6 to 20 carbon atoms of component (B) is 10 mol % or more with respect to all substitution groups on silicon atoms.

10. The UV-curable composition according to claim 1, wherein the viscosity of the entire composition, as measured at 25° C. using an E-type viscometer, is in the range of 5 to 60 mPa·s.

11. An insulating coating agent or insulating adhesive, comprising the UV-curable composition according to claim 1.

12. A cured product of the UV-curable composition according to claim 1.

13. A method of using a cured product of the UV-curable composition according to claim 1 as an insulating coating layer or an insulating adhesive layer.

14. A display device comprising a layer of a cured product of the UV-curable composition according to claim 1.
